(19) United States
(12) Patent Application Publication
(10) Pub. No.: US 2025/0183247 A1
(43) Pub. Date: Jun. 5, 2025

(54) SYSTEM OF MANUFACTURING ELECTRODE AND METHOD OF MANUFACTURING ELECTRODE USING SYSTEM

(71) Applicant: SK On Co., Ltd., Seoul (KR)

(72) Inventors: Min Chan KWON, Daejeon (KR); Song Hyeon KIM, Daejeon (KR)

(21) Appl. No.: 18/937,028

(22) Filed: Nov. 5, 2024

(30) Foreign Application Priority Data
Dec. 5, 2023 (KR) 10-2023-0174361

(51) Int. Cl. H01M 4/04; F26B 13/10

(52) U.S. Cl. CPC H01M 4/04; F26B 13/10

(57) ABSTRACT

A system of manufacturing an electrode is disclosed. The system includes a first drying portion drying a coating material coated on a coating substrate, and a second drying portion selectively drying at least a portion of the coating material that has passed through the first drying portion. According to an embodiment of the present disclosure, a uniform dryness degree of an electrode on which a drying process is completed may be maintained.

### CROSS-REFERENCE TO RELATED APPLICATION(S)

This patent document claims the priority and benefits of Korean Patent Application No. 10-2023-0174361 filed on Dec. 5, 2023, the disclosure of which is incorporated herein by reference in its entirety.

### TECHNICAL FIELD

The disclosure relates to a system of manufacturing an electrode of a secondary battery and a method of manufacturing an electrode using the same.

### BACKGROUND

Unlike primary batteries, secondary batteries may be charged and discharged, and thus may be applied to devices within various fields, such as digital cameras, mobile phones, laptops, hybrid vehicles, and electric vehicles. Recently, research into lithium secondary batteries having high energy density and discharge voltage, among secondary batteries, has been actively conducted.

In general, an electrode plate of a lithium secondary battery may be manufactured through a process of coating an aluminum or copper sheet with a positive electrode active material or negative electrode active material and a process of drying an active material.

The coating process and the drying process may greatly affect the quality of the secondary battery. However, in a case according to the related art, an active material of an electrode plate on which a drying process has been completed may be partially dried for various reasons.

Therefore, there is demand for a drying device and method capable of maintaining a uniform dryness degree.

### SUMMARY

The present disclosure can be implemented in some embodiments to provide a system of manufacturing an electrode of a secondary battery capable of maintaining a uniform dryness degree, and a method of manufacturing an electrode using the same.

The system and method of the present disclosure may be widely applied to a technology field of a secondary battery, such as a pouch-shaped secondary battery and a prismatic-shaped secondary battery.

A secondary battery, manufactured using the system of the present disclosure, may be widely applied in the field of green technology, such as to electric vehicles, battery charging stations, and other battery-utilizing solar power generation schemes, wind power generation schemes, or the like. In addition, the secondary battery of the present disclosure may be used in eco-friendly electric vehicles, hybrid vehicles, and the like, to prevent climate change by suppressing air pollution and greenhouse gas emissions.

According to an aspect of the present disclosure, there is provided a system of manufacturing an electrode, the system including a first drying portion drying a coating material coated on a coating substrate, and a second drying portion selectively drying at least a portion of the coating material that has passed through the first drying portion.

The second drying portion may include a dryness degree measuring portion dividing a measurement region of the coating material into a plurality of unit regions, and measuring a dryness degree of the coating material for each unit region, and a laser drying device selectively drying a dried portion of the coating material having a value less than or equal to a reference value by performing, based on the dryness degree measured by the dryness degree measuring portion, irradiation with a laser for each unit region.

The dryness degree measuring portion may include a plurality of dryness degree measuring devices disposed to be spaced apart from the coating material, and the dryness degree measuring devices may respectively measure dryness degrees of different unit regions.

The dryness degree measuring device may include an irradiation portion irradiating the coating material with a near-infrared ray, and a light receiving portion receiving light reflected from the coating material. The dryness degree measuring device may measure, based on a spectrum of light received by the light receiving portion, a dryness degree of the unit region.

The laser drying device may set, based on the dryness degree of the coating material for each unit region, an output of the laser, and may perform irradiation with the laser having the set output.

The laser drying device may include a plurality of laser irradiation portions arranged in an array form. Each of the laser irradiation portions may irradiate one of the unit regions with a laser.

The laser drying device may include a vertical-cavity surface-emitting (VCSE) laser.

The system may further include a coating portion disposed at a front end of the first drying portion. the coating portion may coat the coating material that is in a slurry state on one surface or both surfaces of the coating substrate.

The first drying portion may include a chamber through which the coating material passes and a heat source applying heat to the coating material in the chamber. The heat source may include at least one of a heater, a near-infrared lamp, a hot air supply device, and a laser irradiation device.

The number of the plurality of dryness degree measuring devices may be equal to or less than the number of the unit regions included in the measurement region, and each of the dryness degree measuring devices may be disposed in an area corresponding to the measurement region.

According to another aspect of the present disclosure, there is provided a method of manufacturing an electrode, the method including a primary drying operation of drying the coating material coated on the coating substrate, and a secondary drying operation of selectively drying at least a portion of the coating material on which primary drying is completed.

The secondary drying operation may include an operation of dividing a measurement region of the coating material into a plurality of unit regions, and measuring a dryness degree of the coating material for each unit region, and an operation of selectively drying a dried portion of the coating material having a value less than or equal to a reference value by performing, based on the dryness degree measured by the dryness degree measuring portion, irradiation with a laser for each unit region.

The operation of selectively drying the coating material may include an operation of irradiating the coating material with the laser by varying a power the laser, based on the dryness degree of the coating material for each unit region.

The operation of measuring the dryness degree of the coating material may include an operation of measuring dryness degrees of first regions, among the unit regions included in the measurement region, and an operation of inferring, based on the measured dryness degrees of the first regions, dryness degrees of second regions on which dryness degree measurement is not performed, among the unit regions.

The operation of inferring the dryness degrees of the second regions may include an operation of defining a dryness degree of the second region as a value between measured dryness degrees of a plurality of the first regions disposed around the second region.

According to an embodiment of the present disclosure, a uniform dryness degree of an electrode on which a drying process is completed may be maintained.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating a system of manufacturing an electrode according to an embodiment of the present disclosure.

FIG. 2 is an enlarged view of portion “A” of FIG. 1.

FIG. 3 is a plan view taken along a direction of “B” of FIG. 2.

FIG. 4 is a perspective view of FIG. 3.

FIG. 5 is a cross-sectional view taken along line I-I′ of FIG. 3.

FIG. 6 is a cross-sectional view taken along line II-II′ of FIG. 3.

FIG. 7 is a cross-sectional view of a dryness degree measuring portion according to another embodiment.

FIG. 8 is a cross-sectional view of a dryness degree measuring portion according to another embodiment.

FIG. 9 is a flowchart of a method of manufacturing an electrode according to an embodiment of the present disclosure.

FIG. 10 is a detailed flowchart of operation S4 of FIG. 9.

### DETAILED DESCRIPTION

Features of the present disclosure disclosed in this patent document are described using example embodiments with reference to the accompanying drawings.

The present disclosure can be implemented in some embodiments to provide a system of manufacturing an electrode of a secondary battery and a method of manufacturing an electrode using the same.

Hereinafter, the present disclosure will be described in detail with reference to the accompanying drawings. However, embodiments are merely exemplary, and the present disclosure is not limited to specific embodiments.

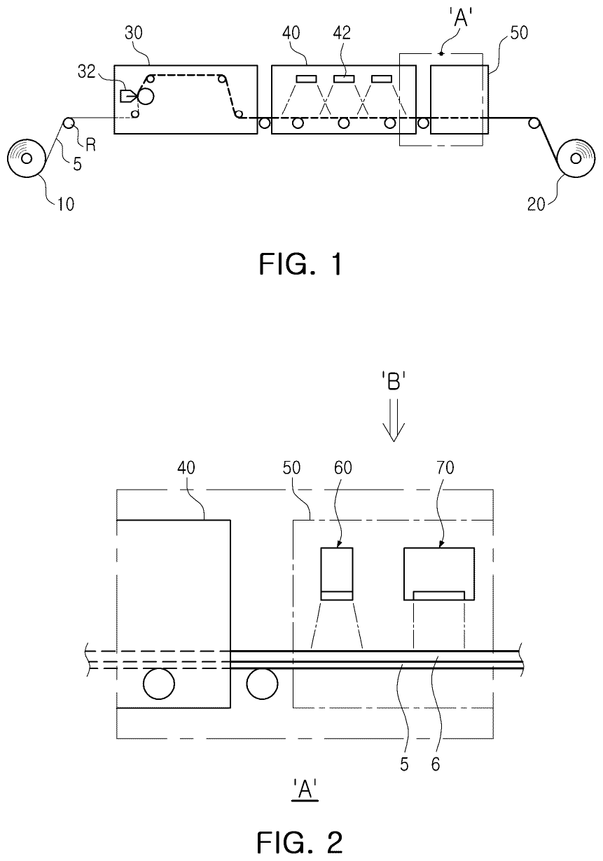

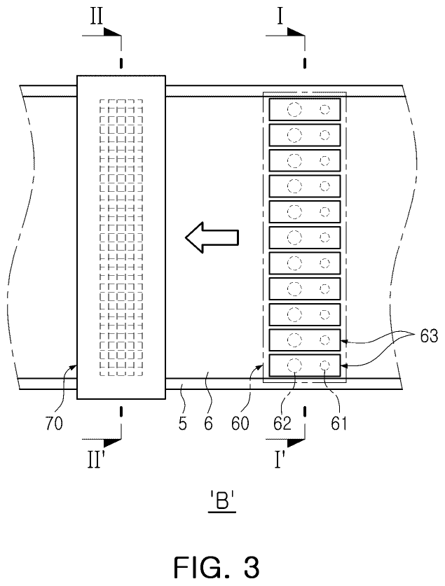

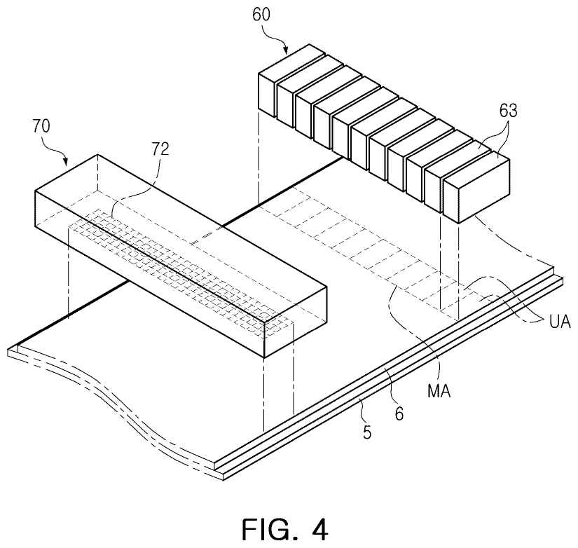

FIG. 1 is a schematic diagram illustrating a system of manufacturing an electrode according to an embodiment of the present disclosure. FIG. 2 is an enlarged view of portion “A” of FIG. 1. FIG. 3 is a plan view taken along a direction of “B” of FIG. 2. FIG. 4 is a perspective view of FIG. 3.

As illustrated in FIG. 1, a system of manufacturing an electrode of a secondary battery according to an embodiment of the present disclosure may include a first drying portion 40 drying a coating material 6 coated on a coating substrate 5, and a second drying portion 50 selectively drying at least a portion of the coating material 6 that has passed through the first drying portion 40.

In one embodiment, the system of manufacturing an electrode of a secondary battery may include an unwinder 10 unwinding and supplying a coating substrate 5, a coating portion 30 coating a coating material 6 on a coating region of the coating substrate 5, a first drying portion 40 drying the coating material 6, a second drying portion 50 selectively performing additional drying on at least a portion of the coating material that has passed through the first drying portion, and a rewinder 20 rewinding the coating substrate 5.

In the present embodiment, the coating substrate 5 may be provided in the form of a thin strip having a predetermined width, and may refer to a metal thin film for manufacturing an electrode of a secondary battery. For example, the coating substrate 5 may be an aluminum thin film when a positive electrode is manufactured, and may be a copper thin film when a negative electrode is manufactured.

The coating substrate 5 may be supplied from the unwinder 10 and coated with the coating material 6 by the coating portion 30. The coating substrate 5 may sequentially pass through the first drying portion 40 and the second drying portion 50, the coating material 6 may be dried, and then rewound by the rewinder 20. To this end, the system of the present embodiment may include a transfer device transferring the coating substrate 5 in the above-described order. For example, the transfer device may include a plurality of rollers R, rotating while supporting the coating substrate 5.

The unwinder 10 may unwind the coating substrate 5, wound in the form of a roll, and may supply the unwound coating substrate 5 to the coating portion 30. As described above, the coating substrate 5, supplied from the unwinder 10, may be a metal thin film such as an aluminum thin film or a copper thin film.

The coating portion 30 may be disposed at a front end of the first drying portion 40 and may coat the coating material 6 that is in a slurry state on one surface or both surfaces of the coating substrate 6.

The coating portion 30 may coat the coating material 6 on the coating substrate 5 supplied from the unwinder 10. To this end, the coating portion 30 may include a slot die coater 32, but the present disclosure is not limited thereto.

An active material that is in a slurry state may be used as the coating material 6, and a coating process may be performed in the same form for both a positive electrode and a negative electrode. In the present embodiment, a case in which the coating material 6 is coated only on one surface of the coating substrate 5 is described as an example, but the coating material 6 may be coated on opposite surfaces of the coating substrate 5, as necessary.

The first drying portion 40 may include a chamber through which the coating material 6 passes and a heat source 42 applying heat to the coating material 6 in the chamber. The heat source 42 may include at least one of a heater, a near-infrared lamp, a hot air supply device, and a laser irradiation device. In one embodiment, the first drying portion 40 may include at least one chamber through which the coating substrate 5 passes, and moisture of the coating material 6 may be removed by applying heat to the coating material 6 passing through the chamber. To this end, the first drying portion 40 may include at least one of various heat sources 42. For example, the first drying portion 40 may include a heater, applying radiant heat to the coating material 6, such as a near-infrared lamp, or may include a hot air supply device, supplying hot air having a preset temperature to the coating material 6. In addition, the coating material 6 may be dried by directly irradiating the coating material 6 with a laser. As described above, the first drying portion 40 of the present embodiment may use various known drying methods in which the coating material 6 may be effectively dried.

A heat source of the first drying portion 40 may apply heat to the entire coating material 6 disposed in the chamber. Accordingly, the coating material 6, disposed in the chamber, may be dried to a predetermined level. However, a portion of a relatively high-moisture region may be left without completely removing moisture.

The second drying portion 50 may include a dryness degree measuring portion 60 dividing a measurement region of the coating material 6 into a plurality of unit regions, and measuring a dryness degree of the coating material 6 for each unit region, and a laser drying device 70 selectively drying a dried portion of the coating material 6 having a value less than or equal to a reference value by performing, based on the dryness degree measured by the dryness degree measuring portion 60, irradiation with a laser for each unit region. The second drying portion 50 may selectively dry at least a portion of the coating material 6 on the coating substrate 5 that has passed through the first drying portion 40. For example, the second drying portion 50 may perform additional drying by selecting a portion, insufficiently dried, of the coating material 6 that has passed through the first drying portion 40. Specifically, the second drying portion 50 may analyze a state of the coating material 6 that has passed through the first drying portion 40. When the coating material 6 includes a portion in which moisture remains, that is, a dried portion having a value less than or equal to a preset reference value, the second drying portion 50 may selectively/locally dry only the portion of the coating material 6. Here, the reference value, a value preset by an operator may refer to a specific parts per million (PPM). In an embodiment, the second drying portion 50 may define a PPM in which moisture of the coating material 6 is sufficiently dried as a reference PPM, and may perform additional drying only on a portion having a PPM greater than or equal to the reference PPM. In addition, in an embodiment, the second drying portion 50 may define the coating material 6 that is in a slurry-state, supplied from the coating portion 30, as a dryness degree of 0%, and the coating material 6 having moisture having 0 PPM as a dryness degree of 100%. Based thereon, a dryness degree % (for example, 90%) effective for manufacturing an electrode may be defined as the reference value.

To this end, the second drying portion 50 may include a dryness degree measuring portion 60 and a laser drying device 70.

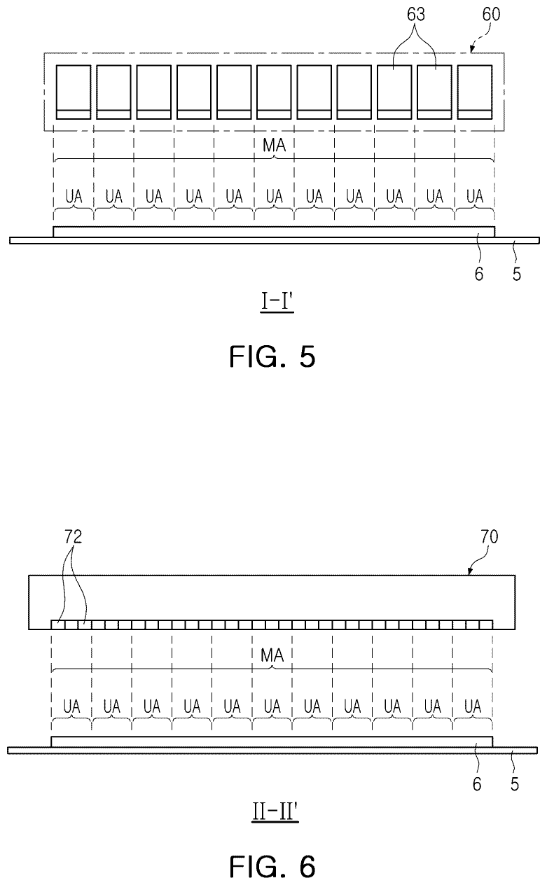

FIG. 5 is a cross-sectional view taken along line I-I′ of FIG. 3. FIG. 6 is a cross-sectional view taken along line II-II′ of FIG. 3.

Referring to FIGS. 5 and 6, the dryness degree measuring portion 60 may consecutively measure a dryness degree of the coating material 6 of the coating substrate 5 that has passed through the first drying portion 40. To this end, the dryness degree measuring portion 60 may repeatedly perform a process of measuring the dryness degree of the coating material 6 with respect to a region MA (hereinafter, referred to as a measurement region) positioned below the dryness degree measuring portion 60 and transmitting a measurement result to the laser drying device 70.

The measurement region MA may be defined as a region in which the dryness degree measuring portion 60 measures at one time. The measurement region MA may be defined as a region in which a plurality of unit regions UA are arranged. Accordingly, the dryness degree measuring portion 60 may divide the measurement region MA into the plurality of unit regions UA, and may measure a dryness degree of the coating material 6 for each unit region UA.

In the present embodiment, the measurement region MA may be defined in a width direction of the coating substrate 5, and may be defined as a region in which the plurality of unit regions UA are one-dimensionally arranged. In addition, the dryness degree measuring portion 60 may include a plurality of dryness degree measuring devices 63 disposed to respectively correspond to the unit region UA. The number of the plurality of dryness degree measuring devices 63 may be equal to the number of the unit regions UA included in the measurement region MA.

The dryness degree measuring device 63 of the present embodiment may be disposed at a position spaced apart from that of the coating material 6 by a predetermined distance, and a dryness degree of the coating material 6 may be measured using near-infrared spectroscopy. The near-infrared spectroscopy may be an analysis method of analyzing reaction of a sample by irradiating the sample with a near-infrared ray, and may irradiate the coating material 6 with light that is in a near-infrared wavelength range and analyze a spectrum of light reflected from the coating material 6 to measure a dryness degree of the corresponding region.

To this end, each dryness degree measuring device 63 may include an irradiation portion 61 irradiating the coating material 6 with a near-infrared ray, and a light receiving portion 62 receiving light reflected from the coating material 6. The dryness degree measuring device 63 may measure, based on a spectrum of light received by the light receiving portion 62, a dryness degree of the unit region UA. In this case, each dryness degree measuring portion 60 may repeatedly perform a process of irradiating the coating material 6 positioned in a corresponding unit region UA with a near-infrared ray and receiving light reflected from the coating material 6.

In the present embodiment, the dryness degree measuring devices 63 may be disposed to be spaced apart from the coating material, and the dryness degree measuring devices 63 may respectively measure dryness degrees of different unit regions UA. However, the present disclosure is not limited thereto, and a single dryness degree measuring device 63 may sequentially measure dryness degrees of the unit regions UA while moving in the width direction of the coating substrate 5. In this case, the dryness degree measuring portion 60 may further include a driving device allowing the dryness degree measuring device 63 to reciprocate in the width direction of the coating substrate 5.

The laser drying device 70 may set, based on the dryness degree of the coating material 6 for each unit region UA, an output of the laser, and may perform irradiation with the laser having the set output. In one embodiment, the laser drying device 70 may set, based on dryness degree data measured by the dryness degree measuring portion 60, an output of the laser for each unit region UA, and may irradiate the coating material 6 with a laser. Accordingly, the laser drying device 70 may selectively/locally the coating material 6.

The laser drying device 70 may include a plurality of laser irradiation portions 72 arranged in an array form. Each of the laser irradiation portions 72 may irradiate one of the unit regions UA with a laser. In one embodiment, the laser drying device 70 may include a plurality of laser irradiation portions 72. The plurality of laser irradiation portions 72 may be disposed in a one-dimensional or two-dimensional array form, and each laser irradiation portion 72 may be disposed toward the coating material 6 to irradiate one of the unit regions UA with a laser. For example, the laser drying device 70 according to the present embodiment may include a vertical-cavity surface-emission (VCSE) laser for irradiation of a laser.

In the laser drying device 70 of the present embodiment configured as described above, the laser irradiation portions 72 may perform irradiation with a laser independently of each other, and may perform irradiation with lasers having different outputs. Accordingly, the unit region UA having a slightly lower dryness degree may be irradiated with a laser having an increased output, and the unit region UA having a dryness degree having a value greater than or equal to a reference value may be irradiated with a laser having a lower output or may not be irradiated with a laser.

The laser drying device 70 of the present embodiment may simultaneously irradiate the entire measurement region MA with a laser. However, the present disclosure is not limited thereto, and the laser drying device 70 may partially irradiate the measurement region MA with a laser several times, as necessary.

The rewinder 20 may rewind the coating substrate 5 that has passed through the second drying portion 50 in the form of a roll. Various known devices capable of stably rewinding the coating substrate 5 may be used as the rewinder 20.

When the dried coating substrate 5 is directly subject to a subsequent process, the rewinder 20 may be omitted.

Next, a manufacturing method using the system of manufacturing an electrode of a secondary battery, illustrated in FIG. 1, will be described.

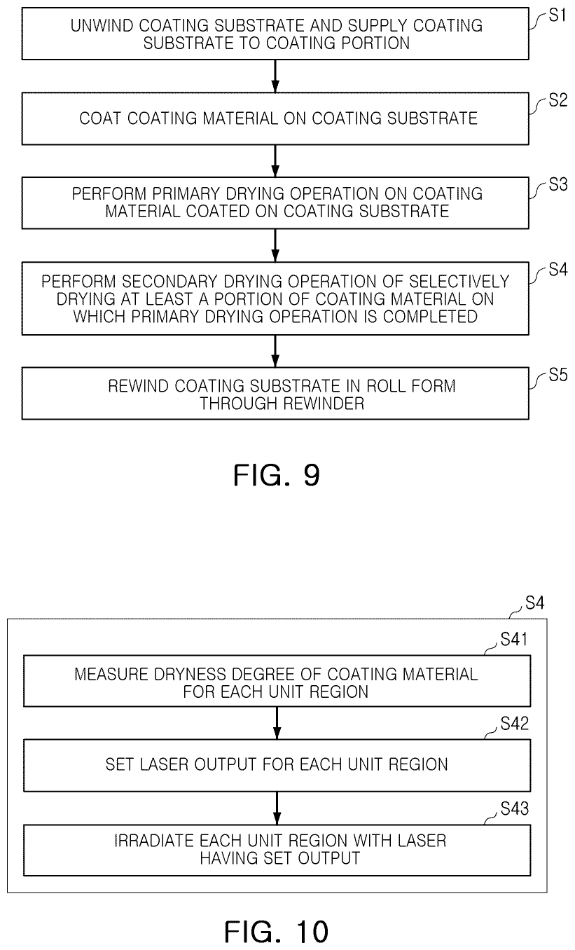

FIG. 9 is a flowchart of a method of manufacturing an electrode according to an embodiment of the present disclosure. FIG. 10 is a detailed flowchart of operation S4 of FIG. 9.

Referring to FIG. 9 and FIG. 10 together, in the method of manufacturing an electrode of a secondary battery according to the present embodiment, may include a primary drying operation of drying the coating material 6 coated on the coating substrate 5, and a secondary drying operation of selectively drying at least a portion of the coating material 6 on which primary drying is completed.

a coating substrate 5, wound in the form of a roll, may be unwound by an unwinder 10 and supplied to a coating portion 30 (S1). As described above, a metal thin film may be used as the coating substrate 5.

The coating portion 30 may coat a coating material 6 on the coating substrate 5 supplied from the unwinder 10 (S2). The coating material 6 may be an active material that is in a slurry state, and may be coated on one surface or opposite surfaces of the coating substrate 5. When the coating material 6 is coated on the coating portion 30, a first drying portion 40 may perform a primary drying operation of drying the coating material 6 (S3). In addition, the coating substrate 5 that has passed through the first drying portion 40 may enter a second drying portion 50.

The second drying portion 50 may perform a secondary drying operation of selectively drying a portion, insufficiently dried, of the coating material 6 on which the primary drying operation is completed (S4). The secondary drying operation may include an operation of dividing a measurement region MA of the coating material 6 into a plurality of unit regions UA, and measuring a dryness degree of the coating material 6 for each unit region UA, and an operation of selectively drying a dried portion of the coating material 6 having a value less than or equal to a reference value by performing, based on the dryness degree measured by the dryness degree measuring portion 60, irradiation with a laser for each unit region UA.

First, a dryness degree measuring portion 60 may measure a dryness degree of the coating material 6 positioned in the measurement region MA of the dryness degree measuring portion 60. In this case, as illustrated in FIGS. 4 and 5, the dryness degree measuring portion 60 may divide a measurement region MA into a plurality of unit regions UA, and may measure a dryness degree of the coating material 6 for each unit region UA using a plurality of dryness degree measuring devices 63 (S41).

Each dryness degree measuring device 63 may irradiate a corresponding unit region UA with a near-infrared ray, may receive light reflected from the coating material 6, and then may analyze a spectrum of the received light to analyze a dryness degree of the corresponding region. The analyzed information may be transmitted to a laser drying device 70.

Such a process may be repeatedly performed according to movement of the coating substrate 5.

Subsequently, an operation of selectively drying, based on the measured dryness degree, the coating material may be performed. The present operation may be an operation in which the laser drying device 70 performs irradiation with a laser for each unit region UA to perform secondary drying on the coating material 6. The operation of selectively drying the coating material may include an operation of irradiating the coating material 6 with the laser by varying a power of the laser, based on the dryness degree of the coating material for each unit region.

The laser drying device 70 may set an output of a laser for each unit region UA, based on information transmitted from the dryness degree measuring device 63, that is, dryness degree data for each unit region UA (S42). In addition, when the measurement region MA, on which dryness degree measurement is performed by the dryness degree measuring portion 60, is positioned in a laser irradiation range, each laser irradiation portion 72 may remove moisture of each unit region UA by irradiating a corresponding unit region UA with a laser having a set output (S43).

In the laser drying device 70 of the present embodiment, a single laser irradiation portion 72 may be configured to take charge of a single unit region UA, or a plurality of laser irradiation portions 72, grouped for each unit region US, may be configured to take charge of a corresponding unit region US. These combinations may be changed according to a size of the unit region UA or an area in which each laser irradiation portion 72 is capable of performing irradiation.

In the present operation, the laser drying device 70 may irradiate a unit region UA having a slightly lower dryness degree with a laser having a relatively high output, and may irradiate a unit region UA having a relatively high dryness degree with a laser having a reduced output. In addition, a unit region UA, determined to be completely dried, may not be irradiated with a laser. For example, in the present operation, when the above-described reference value is a dryness degree of 90%, a unit region UA having a dryness degree of 90% or more may not be irradiated with a laser, a unit region UA having a dryness degree of 50% may be irradiated with 50% of a laser maximum output, and a unit region UA having a dryness degree of 80% may be irradiated with 20% of the laser maximum output.

When the coating material 6 is entirely dried through such a process, the coating substrate 5 may be rewound by the rewinder 20 in the form of a roll (S5).

In the system of manufacturing an electrode of a secondary battery according to the present embodiment configured as described above, even when there is a portion insufficiently dried by the first drying portion 40, the portion may be selected and additionally dried by the second drying portion 50. Accordingly, a uniform dryness degree of the electrode may be maintained, and defects in the electrode, caused by an undried portion, may be prevented.

In addition, in the related art, when the first drying portion 40 is operated, a system of the present embodiment may be implemented by adding only the second drying portion 50 between the first drying portion 40 and the rewinder 20 without the need to replace the first drying portion 40, thereby minimizing equipment replacement costs.

Although not illustrated, a vision inspection device may be additionally disposed between the first drying portion and the second drying portion 50 or at a rear end of the second drying portion 50. The vision inspection device may capture an image of the coating substrate 5 using a camera, and may determine, based on the captured image, a width of the coating material 6 coated on the coating substrate 5, a pattern of the coating material 6, or the like. In addition, a dryness degree of the coating material 6 may also be identified based on a color of the coating material 6.

For example, when a vision inspection device is disposed at a rear end of the second drying portion 50, the vision inspection device may identify a dryness degree of the coating material 6 that has passed through the second drying portion 50, and may adjust an output of the laser irradiation device, based thereon.

Hereinafter, embodiments of the present disclosure will be further described with reference to specific experimental examples. Examples and comparative examples included in the experimental examples are merely illustrative of the present disclosure and do not limit the appended claims, and it is clear to those skilled in the art that various changes and modifications to embodiments can be made within the scope and technical idea of the present disclosure, and it is obvious that such modifications and modifications belong to the appended claims.

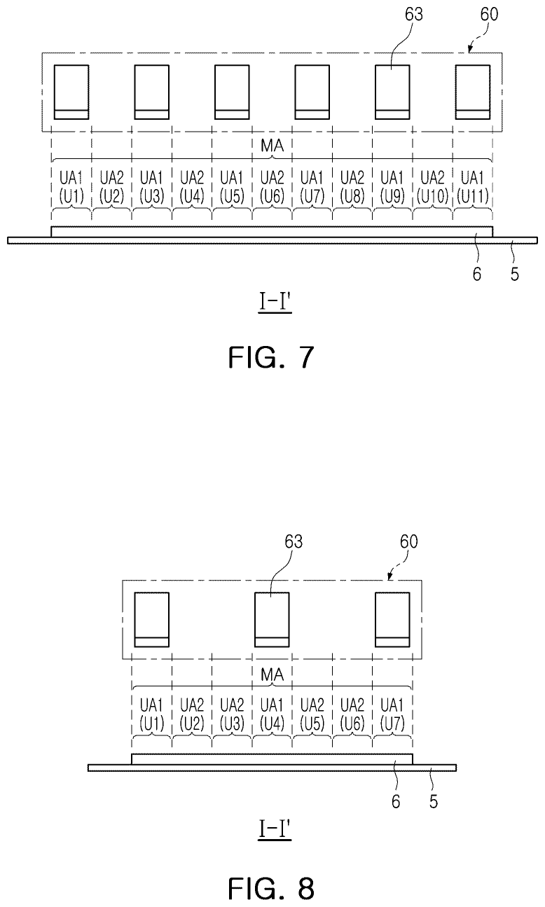

FIGS. 7 and 8 are cross-sectional views of a dryness degree measuring portion according to other embodiments, and illustrate a cross-section taken along line I-I′ of FIG. 3.

The embodiments of FIG. 7 and FIG. 8 may be similar to the above-described embodiments, and may be different from the above-described embodiments only in terms of a configuration of a dryness degree measuring portion 60. Accordingly, the dryness degree measuring portion 60, a difference between the embodiments of FIG. 7 and FIG. 8 and the above-described embodiments, will be mainly described.

In a system of manufacturing an electrode of the present embodiment, the number of the plurality of dryness degree measuring devices 63 may be equal to or less than the number of unit regions UA included in a measurement region MA. In this case, each of the dryness degree measuring devices 63 may be disposed in an area corresponding to the measurement region MA. In one embodiment, the plurality of dryness degree measuring devices 63 may be disposed in an evenly distributed manner corresponding to the entire measurement region MA, and the above-described unit regions may include first regions UA1 on which dryness degree measurement is performed by the dryness degree measuring device 63, and second regions UA2 on which dryness degree measurement is not performed by the dryness degree measuring device 63.

In the present embodiment, a dryness degree of the second region UA2 may be inferred based on a measured dryness degree of the first region UA1. In one embodiment, the operation of measuring the dryness degree of the coating material may include an operation of measuring dryness degrees of first regions UA1, among the unit regions UA included in the measurement region MA, and an operation of inferring, based on the measured dryness degrees of the first regions UA1, dryness degrees of second regions UA2 on which dryness degree measurement is not performed, among the unit regions UA.

For example, as illustrated in FIG. 7, when there are a total of eleven unit regions UA1 and UA2 included in the measurement region MA, and six dryness degree measuring devices 63 are disposed, the dryness degree measuring devices 63 may be disposed to correspond to an odd-numbered unit region (for example, a first region UA1). In addition, the dryness degree measuring devices 63 may not be disposed in an even-numbered unit region (for example, a second region UA2).

When the dryness degree measuring portion 60 is configured as described, a dryness degree of the second region UA2 may not be directly measured. Accordingly, the dryness degree measuring portion 60 of the present embodiment may calculate and use the dryness degree of the second region UA2, based on dryness degrees of the first regions UA1 disposed to be adjacent to the second region UA2.

In general, a dryness degree of the coating material 6 may change in a gentle curved manner in the entire measurement region MA, such that the dryness degree measuring device 63 of the present embodiment may define the dryness degree of the second region UA2 as a value between measured dryness degrees of a plurality of first regions UA1 disposed to be adjacent to the second region UA2.

The operation of inferring the dryness degrees of the second regions UA2 may include an operation of defining a dryness degree of the second region UA2 as a value between measured dryness degrees of a plurality of the first regions UA1 disposed around the second region UA2. Specifically, an appropriate value in a section between the measured dryness degrees in the first regions UA1, respectively disposed on both sides of the second region UA2, may be selected as the dryness degree of the second region UA2.

For example, a dryness degree of a fourth unit region U4 may be defined as an intermediate value (for example, 0.6) in a section (0.5 to 0.7) between a dryness degree (for example, 0.5) of a third unit region U3 and a dryness degree (for example, 0.7) of a fifth unit region U5.

In addition, as illustrated in FIG. 8, when there are a total of seven unit regions UA1 and UA2 included in the measurement region MA, and three dryness degree measuring devices 63 are disposed, the dryness degree measuring devices 63 may be disposed to correspond to the first and seventh unit regions U1 and U7 disposed at opposite ends of the measurement region MA and the fourth unit region U4 disposed at the center of the measurement region MA. In addition, a plurality of second regions UA2 may be consecutively disposed.

In the same manner as the above-described case, dryness degrees of the second regions UA2, consecutively disposed, may be defined as dryness degrees of the second regions UA2 obtained by extracting a plurality of values in a section between dryness degrees of first regions UA1 disposed at opposite sides of the second regions UA2.

For example, in the case of FIG. 8, the dryness degree measuring portion 60 may equally divide a section (0.5 to 0.8) between a dryness degree (for example, 0.5) of a first unit region U1 and a dryness degree (for example, 0.8) of a fourth unit region U4 to calculate two dryness degrees (for example, 0.6 and 0.7) and respectively define the two dryness degrees as a dryness degree of a second unit region U2 and a dryness degree of a third unit region U3.

In the present embodiment, a case is described as an example in which the unit regions UA1 and UA2 are one-dimensionally divided. However, even when the unit regions UA1 and UA2 are arranged in a two-dimensional array form, the dryness degrees of the second regions UA2 may be defined in the same manner.

The system of manufacturing an electrode of a secondary battery according to the present embodiment configured as described above may minimize the number of drying degree measuring devices 63 provided in the drying degree measuring portion 60, thereby minimizing costs required to manufacture or maintain the system.

The above description is merely an example in which a principle of the present disclosure is applied, and other configurations may be further included within a range not departing from the scope of the present disclosure. For example, in the above-described embodiments, a case is described as an example in which a coating material is coated only on one surface of a coating substrate. However, the present disclosure is not limited thereto, and the coating material may be coated on opposite surfaces of the coating substrate. In this case, a drying degree measuring portion and a laser drying device may be disposed on the opposite surfaces of the coating substrate.

Only specific examples of implementations of certain embodiments are described. Variations, improvements and enhancements of the disclosed embodiments and other embodiments may be made based on the disclosure of this patent document.

What is claimed is:

1. A system of manufacturing an electrode, the system comprising:
a first drying portion drying a coating material coated on a coating substrate; and
a second drying portion selectively drying at least a portion of the coating material that has passed through the first drying portion.

2. The system of claim 1, wherein the second drying portion includes:
a dryness degree measuring portion dividing a measurement region of the coating material into a plurality of unit regions, and measuring a dryness degree of the coating material for each unit region; and
a laser drying device selectively drying a dried portion of the coating material having a value less than or equal to a reference value by performing, based on the dryness degree measured by the dryness degree measuring portion, irradiation with a laser for each unit region.

3. The system of claim 2, wherein the dryness degree measuring portion includes a plurality of dryness degree measuring devices disposed to be spaced apart from the coating material, and the dryness degree measuring devices respectively measure dryness degrees of different unit regions.

4. The system of claim 3, wherein
the dryness degree measuring device includes an irradiation portion irradiating the coating material with a near-infrared ray, and a light receiving portion receiving light reflected from the coating material, and
the dryness degree measuring device measures, based on a spectrum of light received by the light receiving portion, a dryness degree of the unit region.

5. The system of claim 2, wherein the laser drying device sets, based on the dryness degree of the coating material for each unit region, an output of the laser, and performs irradiation with the laser having the set output.

6. The system of claim 5, wherein
the laser drying device includes a plurality of laser irradiation portions arranged in an array form, and
each of the laser irradiation portions irradiates one of the unit regions with a laser.

7. The system of claim 6, wherein the laser drying device includes a vertical-cavity surface-emitting (VCSE) laser.

8. The system of claim 1, further comprising:
a coating portion disposed at a front end of the first drying portion, the coating portion coating the coating material that is in a slurry state on one surface or both surfaces of the coating substrate.

9. The system of claim 1, wherein
the first drying portion includes a chamber through which the coating material passes and a heat source applying heat to the coating material in the chamber, and
the heat source includes at least one of a heater, a near-infrared lamp, a hot air supply device, and a laser irradiation device.

10. The system of claim 3, wherein the number of the plurality of dryness degree measuring devices are equal to or less than the number of the unit regions included in the measurement region, and each of the dryness degree measuring devices is disposed in an area corresponding to the measurement region.

11. A method of manufacturing an electrode, the method comprising:
a primary drying operation of drying the coating material coated on the coating substrate; and
a secondary drying operation of selectively drying at least a portion of the coating material on which primary drying is completed.

12. The method of claim 11, wherein the secondary drying operation includes:
an operation of dividing a measurement region of the coating material into a plurality of unit regions, and measuring a dryness degree of the coating material for each unit region; and
an operation of selectively drying a dried portion of the coating material having a value less than or equal to a reference value by performing, based on the dryness degree measured by the dryness degree measuring portion, irradiation with a laser for each unit region.

13. The method of claim 12, wherein the operation of selectively drying the coating material includes an operation of irradiating the coating material with the laser by varying a power of the laser, based on the dryness degree of the coating material for each unit region.

14. The method of claim 12, wherein the operation of measuring the dryness degree of the coating material includes:
an operation of measuring dryness degrees of first regions, among the unit regions included in the measurement region; and
an operation of inferring, based on the measured dryness degrees of the first regions, dryness degrees of second regions on which dryness degree measurement is not performed, among the unit regions.

15. The method of claim 14, wherein the operation of inferring the dryness degrees of the second regions includes an operation of defining a dryness degree of the second region as a value between measured dryness degrees of a plurality of the first regions disposed around the second region.
